(19) United States
(12) Patent Application Publication
(10) Pub. No.: US 2026/0368330 A1
(43) Pub. Date: Nov. 19, 2026

(54) METHOD FOR ADAPTING TEST CASES FOR A SECURITY INSPECTION

(71) Applicant: AVL List GmbH, Graz (AT)

(72) Inventors: Stefan Marksteiner, Vasoldsberg (AT); Markus Wolf, Heimschuh (AT); Peter Priller, Gratwein-Straßengel (AT)

(21) Appl. No.: 19/142,463

(22) PCT Filed: Dec. 22, 2023
(86) PCT No.: PCT/AT2023/060451

§ 371 Date: Jun. 23, 2025

(30) Foreign Application Priority Data
Dec. 23, 2022 (AT) A51002/2022

(51) Int. Cl. G06F 21/57

(52) U.S. Cl. CPC G06F 21/577; G06F 2221/034

(57) ABSTRACT

The invention relates to a computer-implemented method for adapting test cases for a security check of a functional system to be tested of a mobility application, in particular from the automotive and/or aeronautics industries, by a test system, as well as the test system and an associated computer program product. The test system is provided with test cases, which have already been used for security checks of functional systems which are used in or for mobility applications, and/or which are applicable for such security checks.

### TECHNICAL FIELD

The present invention relates to a computer-implemented method for adapting test cases for a security check of a functional system to be tested in a mobility application, in particular from the automotive and/or aeronautics sector, by a test system. For this purpose, test cases are made available to the test system which have been used for security checks of functional systems used in or for mobility applications. Furthermore, the present invention relates to an associated test system and an associated computer program product.

### PRIOR ART

Many modern technical devices, especially vehicles, have a certain level of complexity and contain a large number of embedded and interconnected components, each of which is equipped with its own processors or microcontrollers. However, the present disclosure is not limited to vehicles in the true sense, but can also be used in conjunction with other technical units and systems which have a large number of interconnected components and are used primarily in the automotive and/or aeronautics sector in mobility applications, i.e., for example, in vehicles or in their environment. In connection with the present disclosure, these are generally summarized under the term “functional system.” This means that such a functional system can, for example, be a vehicle itself (e.g., motor vehicle, truck, aircraft, etc.) or a complex system that is used in a vehicle or in conjunction with a vehicle to implement mobility applications.

Examples of such functional systems include, in addition to the vehicles themselves, combinations of different external units/systems with vehicles or vehicle-internal units and systems, combinations of vehicle-internal systems and units, and combinations of several vehicles or units/systems of several vehicles. For example, certain tasks can be performed by an autonomous computer unit (e.g., tablet, smartphone, etc.) that communicates via an interface with a unit or system in an (autonomous) vehicle (e.g., infotainment system, GPS, navigation system, etc.).

In mobility applications, such as autonomous driving (AD) or so-called vehicle-to-X communication, vehicles or in-vehicle systems can exchange data or information with infrastructure units (e.g., traffic lights, barrier systems, etc.) via radio communication, for example. Furthermore, in mobility applications such as driver assistance systems or so-called Advanced Driving Assistance Systems (ADAS for short), units and systems (e.g., sensors, etc.) within a vehicle can communicate with other units and systems (e.g., braking system, engine, etc.) via interfaces. On the other hand, several vehicles can also communicate with each other, e.g., via radio communication, to carry out tasks together—such as being linked together in the sense of a virtual drawbar, or to implement mobility applications, such as vehicle-to-vehicle communication for exchanging information and data between the vehicles. Furthermore, a vehicle, such as a special vehicle in the construction sector, in agriculture, an emergency vehicle, etc., can be connected to one or more on-board devices. Such combined units or systems are considered, in the sense of the present disclosure, to be a functional system that is used in a mobility application (e.g., vehicle, autonomous driving, ADAS, vehicle-to-infrastructure or vehicle-to-vehicle applications, etc.) or is used for the implementation thereof.

Typically, the components of such a functional system have their own storage units and communications interfaces and therefore each form their own computer system. Such components are also referred to as “embedded systems—ES” and perform their tasks—largely invisibly—within the functional system. In the case of a complex overall system (e.g., vehicle, aircraft, etc.), a large number of otherwise autonomous embedded systems are usually networked. Components of such functional systems can also be so-called “Cyber-Physical Systems—CPS.” A cyber-physical system is usually understood to be a network of software units with mechanical and electronic parts that communicate via a data infrastructure (e.g., Internet, bus system, etc.), wherein a cyber-physical system can be formed, for example, by networking embedded systems via a wired and/or wireless communications network and can be used, for example, in mobility applications (e.g., networked security systems, networked driver assistance systems, etc.).

The complexity of such functional systems, especially in the automotive sector and/or aeronautics sector, quickly becomes unmanageable. For example, a vehicle usually has dozens of control units on which software with tens of millions of lines of program code is executed. Examples of communications interfaces include the various wireless connection protocols, such as mobile communications protocols (e.g., 5G, LTE, etc.), Bluetooth, WirelessLAN, RFID, Vehicle-to-X interfaces, etc., which are sometimes used simultaneously. Due to the complexity and the diverse communications interfaces, such functional systems create a large attack surface for cyber attacks, such as so-called denial-of-service (DoS) attacks/flooding. Furthermore, there is also the risk that attacks will be carried out not only via the actual communication interfaces, but also via sensors (e.g., LIDAR, radar system, etc.), wherein such attacks can be carried out, for example, using so-called fake signals. In principle, any event that occurs from outside or inside the functional system having the aim of influencing the functional system in an inadmissible manner and/or forwarding data from the functional system to third parties in an inadmissible manner will be considered a cyber attack.

Due to the physical capabilities of vehicles (mass and speed, thus high kinetic energy, direct interaction with potentially many people), the large number thereof (vehicle fleets), and the progression towards autonomous vehicles, such attacks can develop an enormous risk potential. This applies not only to the large number of vehicles, such as motor vehicles or trucks, but also to rail vehicles, watercraft, and, above all, aircraft. It is therefore important to protect functional systems used in mobility applications—especially in the automotive and aeronautics sectors—against cyber attacks and thus misuse, so that such attacks on the respective system have as little effect as possible or remain as ineffective as possible.

To protect functional systems against cyber attacks and make them resilient, it is important to identify vulnerabilities as early as possible in the development process and, if possible, prevent them. In the conceptual phase, this can be achieved through corresponding architectural measures, as described, for example, in the publication, “Secure Vehicular Communication Systems: Design and Architecture” by Papadimitratos, P., Buttyan, L., Holczer, T., Schoch, E., Freudiger, J., Raya, M., Ma, Z., Kargl, F., Kung, A., & Hubaux, J.-P., 2008, IEEE Communications Magazine, 46(11), 100-109. During the implementation of the concept, this can be done, for example, through appropriate development processes such as best practice, source code review, etc.

After complete assembly and integration of the components into the functional system, there is always the need of a security check of the functional system to find as many relevant vulnerabilities as possible—especially those that only arise through the combination of the components—such as embedded and/or cyber-physical systems. The security check shall allow manufacturers (original equipment manufacturers (OEM's)), government agencies (e.g., regulatory authorities), and other stakeholders (e.g., consumer associations, commercial fleet operators, etc.) to assess the specific risk of a functional system of a mobility application, such as of a vehicle, etc., with respect to cyber attacks. This can be used for the further development or improvement of vehicles or the functional system, for acceptance or certification, and similar tasks. The security check is intended to uncover existing, but initially mostly unknown, vulnerabilities and potential points of attack for cyber attacks, particularly in the functional systems (e.g., vehicle, etc.). In order to uncover vulnerabilities and potential attack points (i.e., initially undetected ways in which a cyber attack on the system to be tested can be carried out), various attacks (e.g., in the form of test vectors) on the functional system to be tested are defined during a security check of a functional system and then applied as system-specific test cases to the functional system to be tested as part of the security check.

For example, security checks are required both during the development of a new vehicle by the OEM, during the market launch/typification/homologation, and then continuously throughout the life of the vehicle or the respective functional system. The need for repeated security checks at the system-test level and thus an ongoing inspection of cybersecurity arises due to changeable configurations, ongoing updates of (parts of the) software components, changed environmental conditions (e.g., vehicle-to-infrastructure (V2I), vehicle-to-vehicle (V2V): changes in interaction partners), newly discovered test vectors (also from in-house security research), etc. The security check can be carried out by, besides the manufacturer, also, for example, also (fleet) operators, regulatory authorities, and specialized third-party companies.

However, due to very restrictive protection and confidentiality policies of manufacturers, especially in the automotive sector, but also in the aeronautics sector, and/or due to an individualized and/or manufacturer-specific design of the functional systems for mobility applications, as a rule, no consistently standardized hardware and software systems are used for functional systems. It is therefore difficult to create generally applicable test cases for security checks that are suitable for making statements about the security or cyber security of functional systems with the same functionality, e.g., from different manufacturers. Even updates to components of a functional system or an update to a functional system can result in the need to create new test cases for security checking, or at least to adapt existing test cases. This means that the functional systems to be tested for security or cyber security are often heterogeneous and largely manufacturer-specific—even if they have the same functionality—so that the test cases for the security check must be created, or at least adapted, in a system-specific and individual manner for each functional system to be tested. Vulnerabilities and possible points of attack may be similar, but existing test cases cannot be directly transferred from a functional system that has already been tested to a functional system that is yet to be tested, due to the individual design of the functional system to be tested. This means that the test cases for the security check must be individually and often manually adapted to the functional system to be tested. This means that security checks of functional systems, such as vehicles, parts, or subsystems of vehicles used in mobility applications, involve a great deal of time and resources.

For example, from document US 2005/0160322 A1, a method and a system are known by which a specific automation test script for detecting errors in an application is converted into an abstract test case representation. The abstract test case representation is then stored in a database for reuse. One or more application states, external interaction sequences, and input data are stored for the abstract test case representation, and the abstract test representation can be supplemented with information from an application metadata repository, so that it can be used to test the application in other test environments or on another test platform. Although this allows test cases to be abstracted for testing an application, the abstract test case representations can be used only to test the same application in a different test environment or on a different test platform.

### PRESENTATION OF THE INVENTION

The invention therefore is based on the task of specifying a method by which test cases, which have already been used in security checks for testing functional systems and/or can be used for such security checks, can be adapted and reused for security checks of further functional systems, which are still to be tested, in a simple, resource-saving, and automated manner.

These and other objects are achieved by a method according to the independent claim. Advantageous embodiments of the present invention are described in the dependent claims.

According to the invention, the object is achieved by a computer-implemented method for adapting test cases for a security check of a functional system, which is used in a mobility application, by a test system. The test cases that have already been applied in security checks on functional systems used in mobility applications and/or are applicable for such security checks are provided to the test system. The method comprises the following steps to be carried out:
dividing the test cases into test modules;
abstracting the test modules, wherein system-specific information, data, and parameters of the functional systems contained in the test modules to which the respective test cases were applied, are replaced in a respective test module by abstract placeholder variables;
creating abstract test scenarios for the security check of the functional system to be tested, wherein the abstracted test modules are combined for a test scenario;
deriving test cases for the functional system to be tested from the abstract test scenarios, wherein the respective abstract placeholder variables in the abstracted test modules of a respective test scenario are assigned corresponding system-specific information, data, and parameters of the functional system to be tested; and
applying the test cases derived from the test scenarios to the functional system to be tested.

The main aspect of the proposed solution is that test cases that are already known or that are already used and/or usable for security checks of functional systems in mobility applications can be generalized and made usable for security checks of new functional systems to be tested in a simple and resource-saving manner, wherein the adaptation to the new functional system to be tested is carried out automatically. The method according to the invention automatically “recycles” test cases that have already been used for security checks of functional systems that are to be newly tested. This means that new test scenarios and specific test cases do not have to be developed for each new functional system to be tested, but, rather, test cases that have already been used in security checks on other functional systems and/or are applicable for them can be used and then automatically adapted for the security check of the functional system to be newly tested. This saves resources and time during the security check.

Furthermore, it is advantageous, if feedback is created for each test case, after applying the test cases derived from the test scenarios to the functional system to be tested. The feedback is then transmitted to the test system and linked in the test system to the respective test scenario from which the respective test case was derived. This makes it very easy to identify, for example, particularly well-functioning test scenarios or poorly functioning test scenarios. The feedback can also be used to record for each test scenario for which functional system it has already been used and how helpful it was, for example, in uncovering security-relevant weak points. This makes it possible to quickly identify good functioning test scenarios or to avoid poorly functioning test scenarios during subsequent security checks of the same or a similar functional system.

It is also advantageous if, during abstraction, the test modules are searched for required parameters which are to be provided by the functional system to be tested or by at least one of the previous test modules for the execution of the respective test module. These required parameters can be stored in a parameter list in the test system, wherein the respective parameter list is linked to the test module abstracted from the respective test module. Furthermore, relations between individual parameters can also be saved in the parameter lists so that they can be used when generating test scenarios. The parameter lists can also be used to quickly identify and eliminate test scenarios that are not useful, non-functional, and/or ineffective when generating test scenarios—for example, if required parameters are not available due to a sequence and/or combination of test modules, etc. Furthermore, the parameter lists can be used to include further steps in the test scenario to determine these parameters—especially when applying the test case derived from the respective test scenario. The generation and execution of these steps, such as determining the parameter or parameter value from the functional system to be tested, etc., can be automated, for example.

It is advisable to search a generated, abstract test scenario for placeholder variables of required parameters which are to be provided to the respective test module by the functional system to be tested and/or by at least one of the preceding test modules for the execution of the test case derived from the test scenario.

Ideally, the parameter lists associated with the respective abstracted test modules of the respective test scenario are used to find the placeholder variables of the required parameters in the respective test scenario. In this way, the placeholder variables and, if applicable, relations between them can be quickly and easily identified and used.

Furthermore, it is advantageous if the abstracted test modules and/or abstract test scenarios and/or parts of abstract test scenarios are stored in the test system, in particular in a database. This allows them to be reused for subsequent security checks of functional systems to be tested. On the one hand, test cases can be adapted more quickly to new functional systems to be tested, and on the other hand, a test module and scenario database is built up, thus further accelerating the method according to the invention. It may also be advantageous to check whether the respective abstracted test module is already stored in the test system, in particular in the database, before storing the respective abstracted test module. This makes it very easy to prevent abstracted test modules from being saved multiple times.

Ideally, in the test system for each abstract test scenario, information is stored indicating which functional system the respective test scenario can be applied to. This allows suitable test scenarios to be found quickly and with little effort for security checks of functional systems to be tested.

A preferred embodiment of the method provides that the system-specific information, data, and parameters of the functional system to be tested for filling the placeholder variables in the abstracted test modules of the respective test scenarios are provided by the test system, in particular by the database, in which empirical values from previous security checks of an identical or similar functional system are stored, and/or by a system manufacturer, and/or are determined by machine learning based on empirical values from previous security checks. However, values determined from an analysis of the functional system to be tested can also be used as system-specific information, data, and parameters of the functional system to be tested, to assign the placeholder variables in the abstracted test modules of the respective test scenarios.

The aforementioned task is also achieved by a test system and a computer product. The test system has at least one computer unit which is configured to carry out the method according to the invention. Expediently, the test system may also comprise a storage unit, such as a database, or be connected to a storage unit, such as a database. This storage unit is ideally configured to store the abstracted test modules, the abstract test scenarios, and/or parts of abstract test scenarios, as well as empirical values from previous security checks of an identical or similar functional system. The test system can also be connected to or have a machine learning system with which the system-specific information, data, and parameters of the functional system to be tested can be determined from empirical values, etc., to fill the placeholder variables in the abstracted test modules of the respective test scenarios.

The computer program product can advantageously be loaded into the test system—for example, into the at least one computer unit—and comprises instructions which, when the computer program product is executed in the test system, cause the computer program product to carry out the method according to the invention.

### BRIEF DESCRIPTION OF THE FIGURES

The present invention is described in greater detail below with reference to FIG. 1 to 2c, which show, by way of example, advantageous embodiments of the invention in a schematic and non-limiting manner. In the figures:

FIG. 1 shows a sequence of the computer-implemented method for adapting test cases of a security check of a functional system to be tested;

FIG. 2a shows an abstraction step of the method according to the invention based upon a specific exemplary embodiment;

FIG. 2b shows a synthesis step of the method according to the invention based upon the specific exemplary embodiment; and

FIG. 2c shows a concretization step of the method according to the invention based upon the specific exemplary embodiment.

### EMBODIMENT OF THE INVENTION

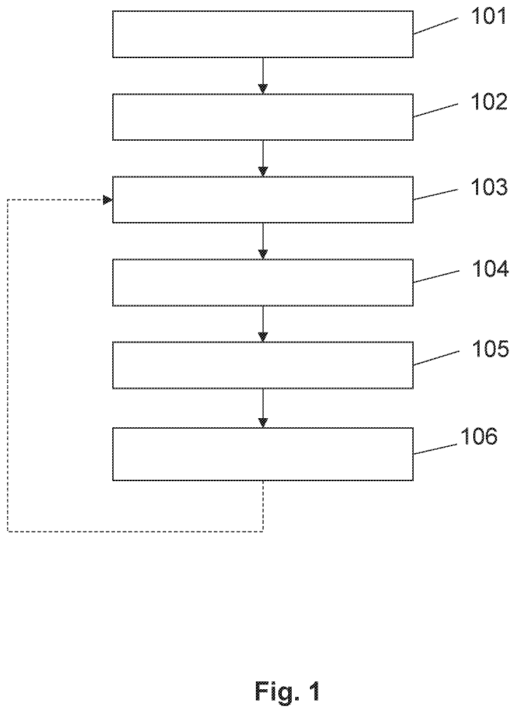

FIG. 1 shows an exemplary sequence of a computer-implemented method with which test cases TC1, which have already been applied in security checks of functional systems by which, for example, mobility applications (e.g., motor vehicles, etc.) are realized and/or which are used in mobility applications (e.g., autonomous driving, vehicle-to-vehicle communication, vehicle-to-X communication, etc.), can be automatically adapted for a security check of a functional system to be tested (e.g., vehicle, vehicle system, etc.). The functional system to be tested can be a newly developed functional system, a further development and/or improvement of an existing functional system, or even a functional system in which individual components (e.g., hardware units, software units, etc.) have been replaced or updated.

The method can be carried out on an associated test system, wherein the test system comprises at least one computer unit. The test system represents an active system that carries out the security check of a system to be tested according to a computer program product, which, for example, can be loaded into an internal memory of the test system and carried out by at least one computer unit or processor. For this purpose, the computer program product comprises instructions which, when executed by the test system, cause the computer program product to carry out the steps of the method according to the invention.

The test system executes corresponding test cases TC1, TC21, . . . , TC23 to, for example, detect vulnerabilities in the functional system to be tested. For this purpose, the test system can, for example, provide interfaces and environment (e.g., test bench or testbed for mobility applications, etc.) and, together with the functional systems to be tested, form a test environment in which the method according to the invention is carried out. Test cases TC1, which have already been used in security checks of other functional systems, are available in the test environment or for the test system. This means that the test system knows test cases TC1 which have already been applied to security checks of functional systems used in mobility applications and/or which can be used for such security checks. A test case TC1, TC21, . . . , TC23 is a test scenario TS1, TS2, TS3 adapted to the respective functional system to be tested and can, for example, be executed on the test system and the functional system to be tested as part of the security check. In the context of this disclosure, test scenario TS1, TS2, TS3 is seen as an abstract description of a test case TC1, TC21, . . . , TC23, wherein the test scenario TS1, TS2, TS3 defines what is to be tested with which means and can describe individual test scenario phases. Test scenarios TS1, TS2, TS3 for functional systems can be obtained, for example, from security analyses and/or from security requirements.

The test system carries out the steps described below and shown as examples in FIG. 1, to adapt a specific test case TC1, which has already been applied to a functional system using the test system, for another functional system that is currently to be tested.

For this purpose, in a modularization step 101, test cases TC1 already used for testing functional systems are analyzed by the test system and divided or broken down into individual test modules T11, T12, T13, T14. A test module T11, T12, T13, T14 can, for example, be a test script which, when executed, represents a targeted attack on the functional system. If necessary, the test module T11, T12, T13, T14 can also consist of only one or more commands.

In a subsequent abstraction step 102, the test modules T11, T12, T13, T14 determined from the test cases TC1 are abstracted. In the test modules T11, T12, T13, T14, the system-specific information, data, and parameters of the functional system to which the respective test case TC1 was applied are replaced by abstract placeholder variables. Thus, in the abstraction step 102, abstracted test modules a1, a2, a3, a4 are created from the specific test modules T11, T12, T13, T14, which are system-specifically adapted for a respective test case TC1. An abstracted test module a1, a2, a3, a4 thus represents a system-agnostic test module that describes a single phase of a test scenario TS1, TS2, TS3 and is agnostic with respect to a specific functional system.

The abstracted test modules a1, a2, a3, a4 can be stored in the test system, e.g., in an associated database. For this purpose, the database can be arranged, for example, in an internal storage unit of the test system or in a storage unit which is connected to the test system. Before storing the respective abstracted test module a1, a2, a3, a4, it can be checked whether this test module a1, a2, a3, a4 is already stored in the test system or in the associated database. In order to be able to store the abstracted test modules a1, a2, a3, a4 in an adequate form in the test system or in the database, a corresponding description language—such as a so-called Domain Specific Language, or DSL for short—is used for the abstracted test modules a1, a2, a3, a4. A Domain Specific Language is a formal language that is designed and implemented for interactions between, for example, people and digitally working units (e.g., computers) for a specific problem area—the so-called domain.

Furthermore, in the abstraction step 102, the test modules T11, T12, T13, T14 can be searched for required parameters before abstraction. Required parameters are, for example, parameters that are absolutely necessary for a reasonable execution of the respective test modules T11, T12, T13, T14. These parameters can be provided, for example, by the functional system to be tested or by one of the test modules T11, T12, T13, T14 preceding the respective test case TC1. However, they can also come from an external source, such as a database, machine-readable specification, etc., or be entered as manual input. Such parameters would, for example, be network addresses of a test target, an identification, and/or a specific mapping address, etc., which must be present when sending a specific command via a component or to a component of the functional system to be tested for the execution of the test module T11, T12, T13, T14, or configuration data. These parameters define, for example, properties (in one step) of the respective test module T11, T12, T13, T14—e.g., to which network address or to which port number a certain message should be sent to or how long this message should be.

Required parameters can occur in each test module T11, T12, T13, T14 and can be specific to the respective test module T11, T12, T13, T14. Furthermore, there may also be required parameters which are necessarily the same for all test modules T11, T12, T13, T14, e.g., of a test case TC1 or also further test cases TC21, TC22, TC23 for the respective functional system, such as the port number. Such parameters can, for example, be defined once for all test modules T11, T12, T13, T14 of a test case TC1 as “global” parameters.

The determined, required parameters of the respective test module T11, T12, T13, T14 can be summarized in a parameter list, for example. In addition to the determined, required parameters of the respective test module T11, T12, T13, T14, relations between individual, required parameters can also be saved in the parameter list, such as that individual parameters must have the same values or result from a combination of other parameters. The parameter lists can be linked to the abstracted test module a1, a2, a3, a4 generated from the respective test module T11, T12, T13, T14. For this purpose, for example, the respective parameter list can be saved in the test system or in the associated database with the respective abstracted test module a1, a2, a3, a4.

Subsequently, in a synthesis step 103, abstract test scenarios TS1, TS2, TS3 are created for the security check of the respective functional system to be tested, by combining the abstracted test modules a1, a2, a3, a4. Abstracted test modules a1, a2, a3, a4, a5, which were generated from various—for example, already applied and/or applicable—test cases TC1, can be combined to form new test scenarios TS1, TS2, TS3 for the security check of the functional system to be tested. The created test scenarios TS1, TS2, TS3 or at least parts of the created test scenarios TS1, TS2, TS3, TS4 can also be saved in the test system or in the associated database—for example, for reuse for similar or the same test requirements. For this purpose, the corresponding description language (e.g., Domain Specific Language) can also be used for the test scenarios TS1, TS2, TS3 as well as for the abstracted test modules a1, a2, a3, a4, a5.

Furthermore, in synthesis step 103, each newly created test scenario TS1, TS2, TS3 can be searched for the required parameters which, when executing a test case TC21, TC22, TC23 derived from the test scenario TS1, TS2, TS3, are to be determined or provided by the functional system to be tested and/or at least one of the preceding test modules T21, T22, T23, T24, T25 to a test module T21, T22, T23, T24, T25. In this way, for example, ineffective, non-functional, and/or non-sensible test scenarios TS1, TS2, TS3 (e.g., due to the order of the abstracted test modules a1, a2, a3, a4, a5) can be identified and eliminated already in synthesis step 103. In order to be able to recognize and locate these required parameters more quickly in the respective test scenario TS1, TS2, TS3, the parameter lists created in abstraction step 102 can be used, for example. For this purpose, the parameter lists are used which are linked to the abstracted test modules a1, a2, a3, a4, a5 used in the test scenario TS1, TS2, TS3.

In a subsequent concretization step 104, specific test cases TC21, TC22, TC23 for the security check of the functional system to be tested are then derived from the abstract test scenarios TS1, TS2, TS3. For this purpose, the respective abstract placeholder variables in the abstracted test modules a1, a2, a3, a4, a5 of the test scenarios TS1, TS2, TS3 are assigned information, data, and parameters of the functional system to be tested. The system-specific information, data, and parameters of the system currently being tested can be provided, for example, by a system manufacturer or by a client of the security check to be carried out. Alternatively or additionally, empirical values from previous security checks of the same or a similar functional system can also be used. These empirical values can also be stored in the test system or in the associated database. Alternatively or additionally, the system-specific information, data, and parameters can at least partially derive from a machine learning system instead of the database, which machine learning system generates the information, data, and parameters based upon empirical values. Furthermore, system-specific information, data, and parameters of the system to be tested, with which the abstract placeholder variables in the abstracted test modules a1, a2, a3, a4, a5 of the test scenarios TS1, TS2, TS3 can be filled, can also be determined from an analysis of the functional system currently to be tested (e.g., scans on the system, port scan, etc.) or from available manufacturer data.

After the concretization step 104, the specific test cases TC21, TC22, TC23 derived from the abstract test scenarios TS1, TS2, TS3 are applied in an application step 105 to the functional system to be tested. In application step 105, for example, during the ongoing security check, it can be documented which specific test cases TC21, TC22, TC23 are particularly well suited for detecting vulnerabilities, which test cases TC21, TC22, TC23 deliver the best results, which test cases TC21, TC22, TC23 do not deliver particularly good results, which test cases TC21, TC22, TC23 do not function or only function incorrectly on the functional system to be tested, etc.

After the application step 105, information collected during the execution of the security check on the respective test cases TC21, TC22, TC23 can then be transmitted to the test system in a feedback step 106. For example, for each test case TC21, TC22, TC23, a feedback can be created, which contains, for example, information on the execution of the respective test case TC21, TC22, TC23. The feedback can be transmitted to the test system and linked there, for example, with the test scenarios TS1, TS2, TS3, from which the test cases TC21, TC22, TC23 were derived. The feedback can then be used to identify particularly well-functioning test cases TC21, TC22, TC23 or test cases TC21, TC22, TC23 that do not function or only function incorrectly. Furthermore, for each abstract test scenario TS1, TS2, TS3, information can be stored on which functional system the respective test scenario TS1, TS2, TS3 has already been applied. This means that, in the case of a new security check of the same or a similar functional system in the test system, test scenarios TS1, TS2, TS3 that have already been tested and are considered successful or well-functioning can be identified in the synthesis step 103 and used again in the concretization step 104 to generate test cases TC21, TC22, TC23. Furthermore, test scenarios TS1, TS2, TS3 that do not work or are not suitable for a specific functional system or are pointless (e.g., due to the test module sequence, not executable on a functional system due to required parameters, etc.) can be easily eliminated from the test system or the associated database. The test system can thus be continuously improved and learn from previously performed security checks—in particular, concretization steps 104.

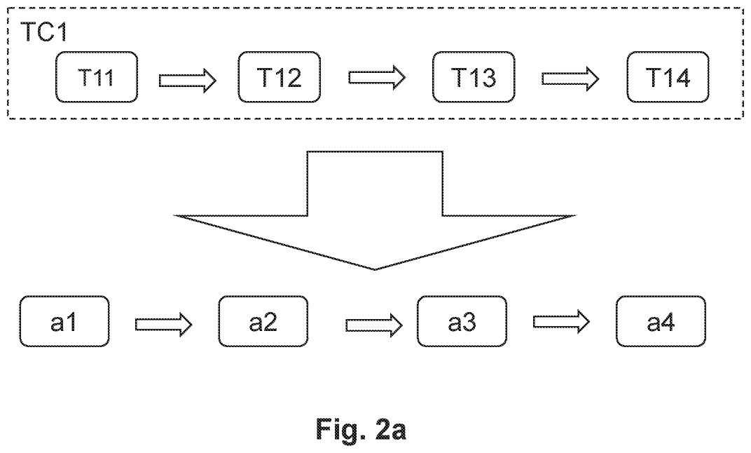

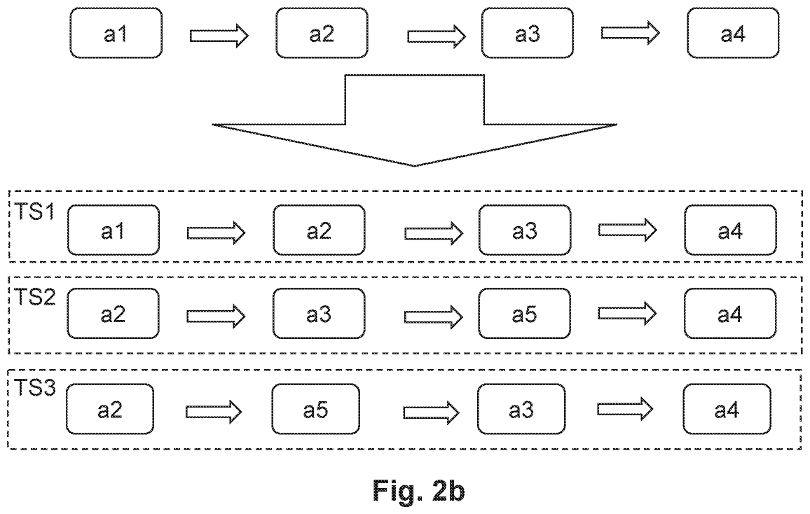

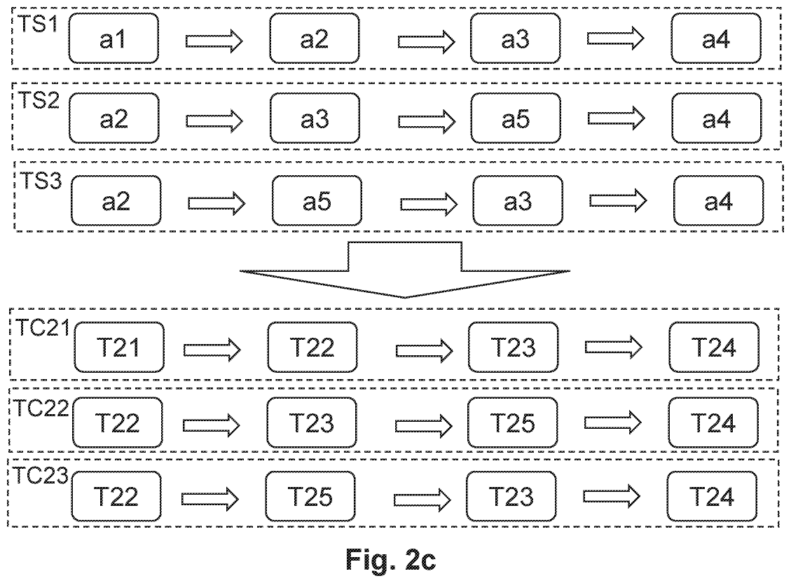

In FIGS. 2a to 2c, the abstraction step 102, the synthesis step 103, and the concretization step 104 of the method are described in more detail using an exemplary embodiment. In the exemplary embodiment, for example, a security check is to be carried out for a specific vehicle for which, for example, after a new development of one or more components or after an update of one or more components, a security check is to be carried out. The aim is to identify, for example, weak points or points of attack for cyber attacks on this vehicle.

FIG. 2a shows by way of example the abstraction step 102. For example, an exemplary specific test case TC1 is used, which has already been applied to a similar functional system (e.g., a vehicle from another manufacturer, etc.) or to the same functional system (e.g., a vehicle before a component replacement or update). The test case TC1, for example, represents a specific attack vector on a functional system that has already been used in a security check. With this specific attack vector, an attempt has been made, for example, to reach the engine control of the functional system or vehicle via an attack on an external interface (e.g., Bluetooth, radio communication, etc.) of the functional system.

The exemplary test case TC1 can, for example, be divided into four test modules T11, T12, T13, T14 in modularization step 101. For example, each test module T11, T12, T13, T14 corresponds to a specific attack on a component or subsystem of the tested functional system or vehicle. The first test module T11 can, for example, represent an attack on an external interface of the vehicle, with which, for example, existing external interfaces (e.g., wireless communication interface, sensors, etc.) are detected. A second test module T12 attempts to access the vehicle's infotainment system, for example, after a successful attack using the first test module T11. If the second test module T12 is successfully executed, a third test module T13 attempts to attack or use the vehicle's internal network, for example. If the third test module T13 is successful, an attempt is made, for example, in a fourth test module T14 to take over the engine control of the vehicle.

In the abstraction step 102, the specific test modules T11, T12, T13, T14, into which the specific test case TC1 was divided, are now abstracted. This means that, in the test system, all system-specific information, data, and parameters of the vehicle tested with test case TC1 contained in the test modules T11, T12, T13, T14 are removed and replaced by abstract placeholder variables. The test modules T11, T12, T13, T14 thus become abstracted test modules a1, a2, a3, a4, which describe the respective attacks abstractly. For example, an abstracted test module a1 derived from the first test module T11 can contain the description to search for a wireless interface of (any) functional system and to establish a connection with it. A second abstracted test module a2 derived from the second test module T12 can, for example, contain the description of establishing a connection to a component or subsystem of the functional system that can be reached via the found interface after a successful connection to the wireless interface. In a third abstracted test module a3 derived from the third test module T13, for example, the use of an internal network of the functional system is described abstractly. For example, a fourth abstracted test module a4 can abstractly describe the transfer of control of the functional system. The abstracted test modules a1, a2, a3, a4 can be stored, for example, in the test system or in the associated database, provided that these abstracted test modules a1, a2, a3, a4 are not already stored in the test system or in the associated database.

Furthermore, the test modules T11, T12, T13, T14 can be searched for required parameters before abstraction, and test-module-specific parameter lists can be generated accordingly. The respective test-module-specific parameter list can be linked to the respective abstracted test module a1, a2, a3, a4 and stored with it in the test system or in the associated database.

FIG. 2b shows the synthesis step 103 of the method using the exemplary embodiment, such as a security check of a vehicle currently being tested. The abstracted test modules a1, a2, a3, a4, a5 are combined into abstract test scenarios TS1, TS2, TS3, wherein each test scenario TS1, TS2, TS3 represents an abstract description of a possible attack vector. To create the test scenarios TS1, TS2, TS3, for example, the abstracted test modules a1, a2, a3, a4 derived from the specific test case TC1 in the abstraction step 102 as well as further abstracted test modules a5, which were abstracted from test cases TC1 of further, already performed, security checks, can be used. Furthermore, abstracted test modules a5 can also be used, which are already stored in the test system or in the associated database.

In the synthesis step 103 shown in FIG. 2b, for example, the abstracted test modules a1, a2, a3, a4 generated in the abstraction step 102 shown in FIG. 2a are combined to form a first test scenario TS1. In a further, second test scenario TS2, for example, the second, third, and fourth abstracted test modules a2, a3, a4 from the specific test case TC1 are combined with a fifth abstracted test module a5 (e.g., an abstract description that a connection to a system-internal component (e.g., gateway) is to be established and/or used), wherein the fifth abstracted test module a5 is inserted, for example, between the third and fourth abstracted test modules a3, a4. In a further, third test scenario TS3, the second, third, and fourth abstracted test modules a2, a3, a4 are also combined with the fifth abstracted test module a5, wherein, in the third test scenario, the fifth abstracted test module a5 is arranged, for example, between the second and the third abstracted test modules a2, a3.

In synthesis step 103, abstract test scenarios TS1, TS2, TS3 can be created by the test system using any combination of the abstracted test modules a1, a2, a3, a4, a5. In order to exclude, for example, ineffective or pointless combinations of abstracted test modules a1, a2, a3, a4, a5—such as a combination in which, for example, the fourth abstracted test module a4 (e.g., taking over control of the functional system) is arranged before the first test module a1 (e.g., searching for external interfaces of the functional system as a point of attack)—the created, abstract test scenarios can be searched for required parameters, or the parameter lists stored in the respective abstracted test modules a1, a2, a3, a4, a5 can be evaluated. Furthermore, suggestions for combinations of abstracted test modules a1, a2, a3, a4, a5 available in the test system or in the associated database can be used to create test scenarios TS1, TS2, TS3. Furthermore, the created abstract test scenarios TS1, TS2, TS3 or at least part thereof can be stored in the synthesis step 103 in the test system or in the associated database—for example, as suggestions for creating test scenarios TS1, TS2, TS3 in later synthesis steps 103.

FIG. 2c shows the concretization step 104 of the method using the specific exemplary embodiment—for example, the security check of a vehicle currently being tested. In concretization step 104, specific test cases TC21, TC22, TC23 for the functional system currently to be tested—e.g., a vehicle with at least one newly developed or updated component—are derived from the abstract test scenarios TS1, TS2, TS3 created in synthesis step 103. The abstract placeholder variables in the abstracted test modules a1, a2, a3, a4, a5 of the respective test scenarios TS1, TS2, TS3 are filled with system-specific information, data, and parameters of the functional system or vehicle currently being tested. The first test scenario TS1 thus becomes a specific, first test case TC21 for the security check of the vehicle currently being tested. Furthermore, the second test scenario TS2 and the third test scenario TS3 become a specific, second test case TC22 and a specific, third test case TC23, respectively. The system-specific information, data, and parameters can come from the client of the security check or from the vehicle manufacturer's data. For example, empirical values from previous security checks of the vehicle or similar vehicles can be used, or data from analyses, etc., of the vehicle currently being tested can be used.

The test cases TC21, TC22, TC23 derived in concretization step 104 are then used in application step 105 for the security check of the functional system or vehicle currently being tested. The findings and experiences from the application of the test cases TC21, TC22, TC23 can then be transmitted to the test system in the feedback step 106 in the form of feedback on the test cases TC21, TC22, TC23. There, they can be linked and stored with the corresponding test scenarios TS1, TS2, TS3 to be able to use the feedback again in subsequent security checks of functional systems.

1. A computer-implemented method for adapting test cases for a security check of a functional system of a mobility application to be tested by a test system, wherein the test system is provided with test cases which have been used in security checks of functional systems used in mobility applications or are applicable for such security checks, the method comprising the following steps:
dividing the test cases into test modules;
abstracting the test modules, wherein system-specific information, data, and parameters of the functional systems contained in the test modules, to which the respective test cases were applied, are replaced by abstract placeholder variables in a respective test module;
creating abstract test scenarios for the security check of the functional system to be tested, wherein the abstracted test modules are combined for a test scenario;
deriving test cases for the functional system to be tested from the abstract test scenarios, wherein the respective abstract placeholder variables in the abstracted test modules of a respective test scenario are assigned corresponding system-specific information, data, and parameters of the functional system to be tested; and
applying the test cases derived from the test scenarios to the functional system to be tested.

2. The method according to claim 1, wherein, after applying the test cases derived from the test scenarios to the functional system to be tested, a feedback is generated for each test case, and the feedback is transmitted to the test system and is linked with the respective test scenario, from which the respective test case was derived, in the test system.

3. The method according to claim 1, wherein, during abstraction, the test modules are searched for required parameters which are to be made available for execution of the respective test module by the functional system to be tested or by at least one of the preceding test modules, and the required parameters are stored in a parameter list in the test system, wherein the respective parameter list is linked to the test module abstracted from the respective test module.

4. The method according to claim 1, wherein a created, abstract test scenario is searched for placeholder variables of required parameters which are to be provided to the respective test module by the functional system to be tested or by at least one of the preceding test modules for executing the test case derived from the test scenario.

5. The method according to claim 4, wherein the parameter lists linked to the respective abstracted test modules of the respective test scenario are used to find the placeholder variables of the required parameters in the respective test scenario.

6. The method according to claim 1, wherein the abstracted test modules or abstract test scenarios or parts of abstract test scenarios are stored in the test system, in particular in a database.

7. The method according to claim 6, wherein a check is made as to whether the respective abstracted test module is already stored in the test system, in particular in the database, before storing the respective abstracted test module.

8. The method according to claim 1, wherein for each abstract test scenario, information is stored in the test system, to which functional systems the respective test scenario has been applied to.

9. The method according to claim 1, wherein the system-specific information, data, and parameters of the functional system to be tested, which are used for filling the placeholder variables in the abstracted test modules of the respective test scenarios, are provided by the test system, in particular from the database, in which empirical values from previous security checks of an identical or similar functional system are stored or by a system manufacturer or are determined using machine learning based on empirical values from previous security checks.

10. The method according to claim 1, wherein values determined from an analysis of the functional system to be tested are used as system-specific information, data, and parameters of the functional system to be tested to assign the placeholder variables in the abstracted test modules of the respective test scenarios.

11. A test system with at least one computer unit which is configured to carry out the method or claim 1.

12. The test system according to claim 11, wherein the test system further comprises at least one storage unit or is connected to a storage unit, the storage unit being configured to store abstracted test modules, abstract test scenarios, or parts of abstract test scenarios, as well as empirical values from previous security checks of an identical or similar functional system.

13. A computer program product, wherein the computer program product is configured to be loaded into the test system, and wherein the computer program product comprises instructions which, when executed by the test system, cause the computer program product to carry out the method according to claim 1.
